(19) United States
(12) Patent Application Publication
(10) Pub. No.: US 2017/0165816 A1
(43) Pub. Date: Jun. 15, 2017

(54) HAMMER WRENCH FOR HAMMER UNION

(71) Applicant: Fabrication of Rig and Exploration Equipment, Inc., Cleveland, TX (US)

(72) Inventor: David A. Wells, SR., Cleveland, TX (US)

(21) Appl. No.: 14/969,577

(22) Filed: Dec. 15, 2015

(51) Int. Cl. B25B 19/00; B25B 13/50; B25B 13/06

(52) U.S. Cl. CPC B25B 19/00; B25B 13/06; B25B 13/50

(57) ABSTRACT

A hammer wrench has a body having pockets placed in an inner surface of the body, each of the pockets in radial arrangement about an axis such that each pocket is displaced substantially sixty degrees from at least one neighboring pocket. A hammer post, can extend radially from an outer arced surface of the body, and expose a first flat face lying within a 15° tolerance of a first plane that extends through the axis. The hammer post can expose a second flat face lying within a 15° tolerance of a second plane that extends through the axis. In addition, the body has at least two distal ends that that are more remote from the hammer post than any of the at least three pockets, the at least two distal ends providing a gap therebetween that is wider than an inner diameter of at least one of the pipes.

### BACKGROUND

The present invention relates to tools used in plumbing, and in particular to torque producing tools used with union nuts.

Industrial operations, particularly those that are set-up temporarily, can require the assembly and disassembly of large gauge pipes. Typically, two pipes are joined through the use of a union nut, sometimes called a hammer union. When the two pipes are joined with the hammer union, the hammer union provides the necessary pressure to seal the joint.

For pipes with diameters of a foot or more, the friction presented by the pipe threads to the hammer union can be substantial. As the length of engaged pipe thread increases, so too does the amount of friction between the pipe and the hammer union. This condition is amplified by irregular wear on the union or pipe threads, as well as the weight of one or more of the pipes, which may rely, in part, on the hammer union for support.

FIG. 1 shows a hammer union having three wings or teeth that extend outwards from the hammer union 101, 103 and 105. Unlike the wings on a manually operated wing-nut, the hammer union wings are substantially reinforced so that a hammer may strike any one along a circumferential direction to the hammer union. Stiction is a force that resists moving the hammer union while at rest in its threaded state with a pipe. Accordingly, the strike of the hammer must drive enough torque on the hammer union to overcome stiction and move the hammer union to a looser, and less-engaged position relative to the threads of a pipe 110.

The torque applied to the hammer union is limited by the moment arm of each wing, which is roughly double the radius of the threads of the hammer union. This configuration forces the roughnecks and other industrial workers to strike with the wing with a large hammer at great velocity. Such an arrangement risks injury from ricocheting hammers or fragmenting hammer unions. Risks of injury can be reduced if the moment arm could be extended somehow.

In addition, some hammer unions, while engaged to the pipes, can become stuck, such that removal becomes impossible without extreme measures, such as cutting out the pipe union altogether.

Furthermore, the act of attaching the hammer union to the pipes can itself require the use of the hammer to properly tighten the hammer union. The application of the hammer, particularly presenting torque and forces that are relatively unbalanced, can lead to wear on the joint which can make the assembly hazardous for industrial application. The industrial application can be the passing of fluids through the union. When such hazardous unions are detected, the entire assembly needs to be reworked.

These and other concerns need to be addressed somehow.

### SUMMARY

Disclosed is hammer wrench for applying torque to a union used to join pipes. The hammer wrench may include a body having at least three pockets placed in an inner surface of the body, each of the pockets being placed in radial arrangement about an axis such that each pocket is displaced substantially sixty degrees from at least one neighboring pocket. A hammer post, can extend radially from an outer arced surface of the body, and expose a first flat face lying within a 15° tolerance of a first plane that extends through the axis. The hammer post can expose a second flat face lying within a 15° tolerance of a second plane that extends through the axis. In addition, the body has at least two distal ends that that are more remote from the hammer post than any of the at least three pockets, the at least two distal ends providing a gap therebetween that is wider than an inner diameter of at least one of the pipes.

### BRIEF DESCRIPTION OF THE DRAWINGS

FIG. 1 shows a hammer union having three wings or teeth that extend outwards from the hammer union;

FIG. 2 is a top view of a hammer wrench in accordance with an embodiment of the invention;

FIG. 3 shows capture element in alignment with, and prepared for bolting to, a hammer wrench in accordance with an embodiment of the invention;

FIG. 4 is a top view of capture element in accordance with an embodiment of the invention; and

FIG. 5 is a perspective exploded view of the assembly of hammer wrench, capture element 260 and two bolts in accordance with an embodiment of the invention

### DETAILED DESCRIPTION

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

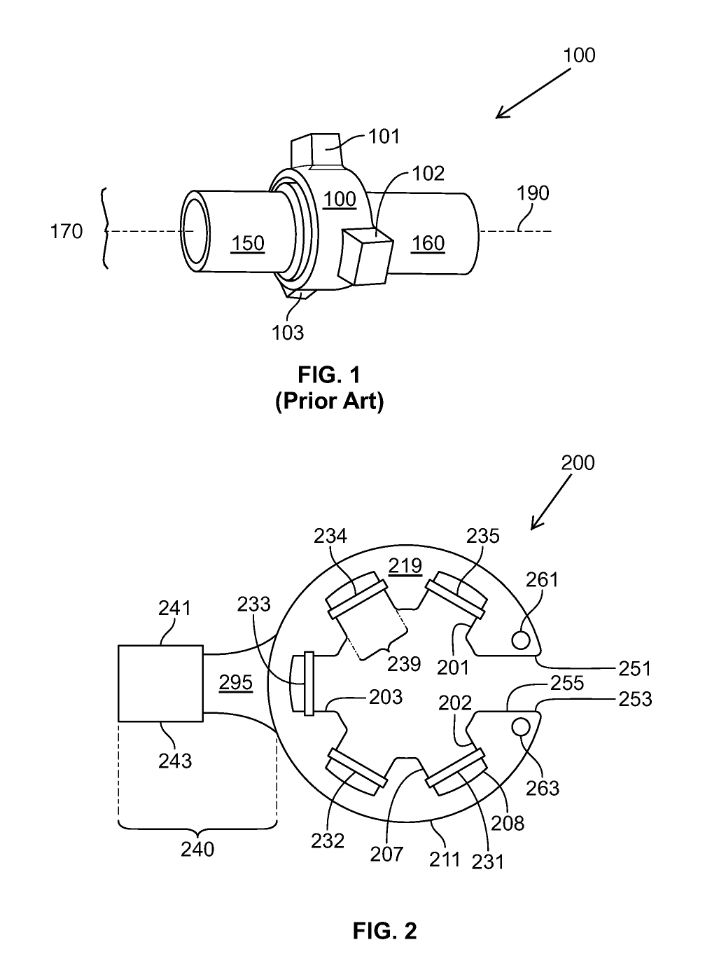

With reference now to the figures and in particular with reference to FIG. 1, a prior art hammer union in engagement with two pipes is shown. Hammer union 100 has three wings 101, 102 and 103 that present surfaces that are amenable to striking with a hammer in a circumferential direction about the axis of the pipes, depicted as axis 150 phantom line. It is with respect to at least the hammer faces 111, 113, 115, that the disclosed embodiments are primarily used to drive torque on hammer union 100. Thus pipe 150 is joined to pipe 160.

FIG. 2 is a top view of a hammer wrench in accordance with an embodiment of the invention. Hammer wrench 200 is applied by inserting a pipe of the union through distal ends 251, 253 of hammer wrench 200. The gap between distal ends 251, 253 is sufficient to permit one of the pipes to fit therebetween with some excess tolerance to allow easy mating of hammer wrench 200 to, for example, the hammer union 100 of FIG. 1.

Hammer wrench 200 when placed with wings of the hammer union within at least two pockets within a C-shaped body 250 provides two striking surfaces on hammer post 240, namely upper strike surface 241 and lower strike surface 243. The post may extend from an axis of rotation such that the moment arm is twice the distance of a face of a wing of the hammer union.

A pocket is an indentation within an inner surface of a c-shaped body that is arranged at either a 60° or 120° offset from a neighboring pocket. Pocket 239 is exemplary of the pockets. Each pocket is designed to admit a wing of a hammer union plus some tolerance for alignment and engagement of the hammer wrench, at least from one side of the hammer wrench. Each pocket has a clockwise-driving face, for example, faces 202, 203 and a counter-clockwise-driving face, for example, face 201. Accordingly, a strike at lower strike surface 243 will drive the hammer wrench 200 clockwise and transmit forces generally perpendicular to each of face 202 and face 203.

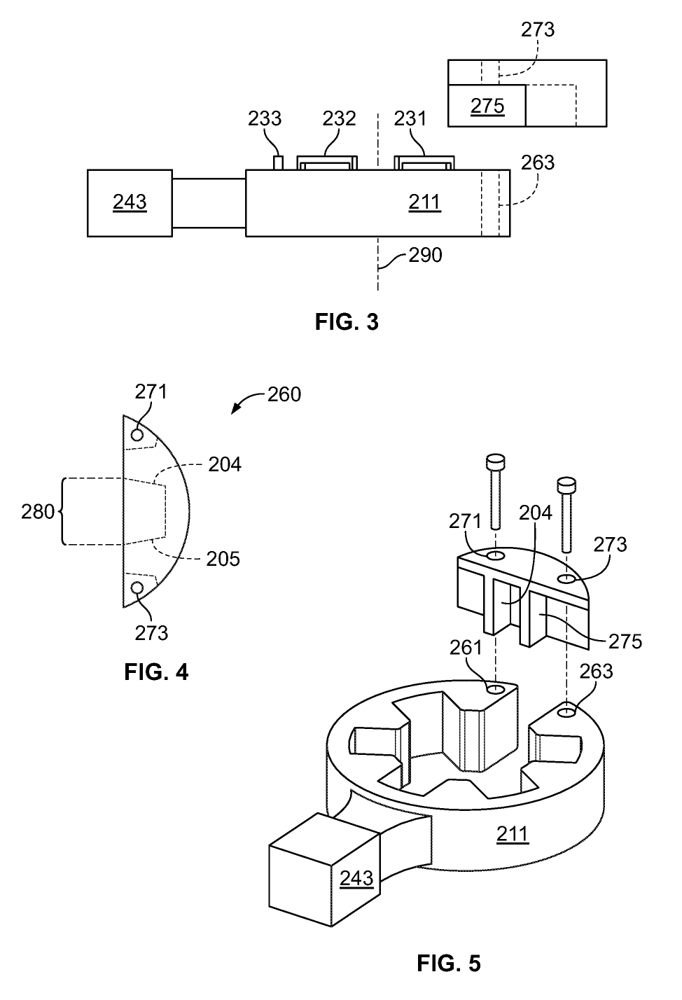

Each strike surface can be arranged to be flat and lie within a certain tolerance of a plane that passes through the longitudinal axis of the pipes to be fitted, for example, axis 150 of FIG. 1. Typical use of the hammer wrench will align axis 290 of FIG. 3 with axis 150 of FIG. 1 so that hammer wrench may engage with its work-piece, the hammer union. In other words, with reference to FIG. 3, axis 290 extends perpendicular to a plane of the c-shaped body 250 from the center of the ‘c’ of the c-shaped body. The tolerance in some embodiments, is 15°. In other words, strike surface 241 and 243 are arranged to be within 15° of planes intersecting axis 290. It is appreciated that both the axis and the planes that intersect axis as radial planes, are not physical parts, but rather are orienting constructs with respect to the body of illustrative embodiments, and in particular C-shaped body 250. Further, it is understood, that though C-shaped body 250 is shown with curved outer surfaces, the outer surfaces can be hexagonal, square, or any other shape that provides a gap between distal ends. Likewise, an inner surface of C-shaped body, to the extent that it is non-contiguous due to the presence of pockets, can be generally circular, or hexagonal with respect to the axis 290.

Outer arced surface 211 can largely envelope the hammer union with the exception of the gap between distal end 251 and distal end 253. Additional integrity can be added to the hammer wrench 200 by adding capture element 260 to the gap, once the hammer wrench 200 is placed in contact with the hammer union, as better seen in FIG. 3. Capture element 260 can be bolted to corresponding hammer wrench hole 261, 263 through holes in capture element 271, 273.

FIG. 3 shows capture element 260 in alignment with, and prepared for bolting to, hammer wrench 200 in accordance with an embodiment of the invention. Capture element presents face 275 to engage with hammer wrench face 255, while capture element 260 provides a similar face to bridge the gap to the other distal end of the hammer wrench 200.

FIG. 4 is a top view of capture element in accordance with an embodiment of the invention. A supplemental pocket within capture element 260 is large enough to admit a wing to hammer union 100. Disposed in supplemental pocket 280 is clockwise-driving face 204 and counter-clockwise-driving face 205.

FIG. 5 is a perspective exploded view of the assembly of hammer wrench, capture element 260 and two bolts in accordance with an embodiment of the invention. Assembly can be performed after hammer wrench 200 is placed with a pipe within its core. In other words, the c-shape of the hammer body may nearly encircle the pipe. Bolt 291 can be placed within capture element hole 271 through to hammer wrench hole 261. Bolt 293 can be placed within capture element hole 273 through to hammer wrench hole 263. Nuts (not shown) can be added to the bottom of bolts 291, 293 to secure the assembly. Capture element 260, in this configuration, can place face 275 in secure contact with hammer wrench face 255 to transmit torques circumferentially about the perimeter of the entire assembly. As such, pocket 280 of capture element 260 can itself be used as a place to engage a wing of hammer union 200.

Bars 231, 232, 233, 234, 235 can operate to rest the hammer wrench on a horizontally disposed hammer union, as can occur when the axis is substantially vertical. Otherwise, in other orientations, bars, 231, 232, 233, 234, 235 can perform as stops by engaging with three of the wings to better align faces (e.g., 201, 202, 203) to the hammer union wing faces. Bars may, in alternative embodiments, be replaced by extending upper surface 219 of hammer wrench 200 to provide a kind of roof over each pocket. Such a covering or roof to each pocket need not be contiguous, and can provide holes or other openings through which to see how each wing aligns to the hammer wrench. Still further embodiments, not in the figures, may use a flange to extend from the upper surface 219 to partially obstruct each pocket by extending from, for example, an upper edge to face 202, face 207 and face 208 for each pocket.

Webbing 295 of the hammer post 240 can be arranged with cavities to make the hammer wrench lighter and provide for placing a center of gravity of the hammer wrench without the capture element, at or near bar 233 in order to enhance the ability to use the bar 233 as a handle. Moreover, some embodiments of the invention may place this bar with one joint to the c-shaped body farther from the axis and a second joint of the c-shaped body closer to the axis in order to make carrying the wrench easier without the hammer post chafing parts of a worker's arm. Similarly, in some embodiments, cavities can be added to upper surface, as needed, to improve portability of the hammer wrench or otherwise adjust the center of gravity of the hammer wrench.

Further embodiments, may permit the capture element to be attached by a hinge at one distal end, and a latch at a second distal end, so that the capture element, is flexible to admit a pipe between the distal ends, while unlatched. Conversely, an operator may move the capture element about a hinge, to latch to suitable hardware on the opposite distal end into a closed configuration.

Accordingly, illustrative embodiments disclose an apparatus and/or method to attach and detach hammer unions through the use of a hammer wrench. The hammer wrench can be used in light-duty situations without a capture element. In addition, for more heavy-duty situations, the capture element can be bolted to the distal ends of the hammer wrench to give greater integrity to the assembly, and permit lighter construction of the hammer wrench.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A hammer wrench for applying torque to a union used to join pipes, the hammer wrench comprising:
a body having at least three pockets placed in an inner surface of the body; each of the pockets being placed in radial arrangement about an axis such that each pocket is displaced substantially sixty degrees from at least one neighboring pocket;
a hammer post, extending radially from an outer arced surface of the body, and exposing a first flat face lying within a 15° tolerance of a first plane that extends through the axis, and exposing a second flat face lying within a 15° tolerance of a second plane that extends through the axis; and
wherein the body has at least two distal ends that that are more remote from the hammer post than any of the at least three pockets, the at least two distal ends providing a gap therebetween that is wider than an inner diameter of at least one of the pipes.

2. The hammer wrench of claim 1 wherein the at least three pockets comprise five pockets.

3. The hammer wrench of claim 1, wherein each of the at least three pockets has a bar that substantially obstructs passage of a wing to a union at an upper surface to the body.

4. The hammer wrench of claim 3, wherein a proximal pocket is present closest to the hammer post among all of the at least three pockets, and a corresponding bar to the proximal pocket is proximal to a center of gravity of the hammer wrench.

5. The hammer wrench of claim 4, wherein being proximal to the center of gravity comprises the corresponding bar being along a longitudinal line in relation to the center of gravity.

6. The hammer wrench of claim 1, wherein each of the at least three pockets has a flange that partially obstructs passage of a wing to a union near an upper surface to the body.

7. The hammer wrench of claim 1, wherein each distal end has a longitudinal through-hole for admitting a pin of a coordinating capture element.

8. The hammer wrench of claim 1, wherein a first at least two distal ends attaches to a coordinating capture element by a hinge.

9. The hammer wrench of claim 8, wherein the coordinating capture element, when attached in a closed configuration, relative to the c-shaped body provides a pocket arranged at a 120° angle to at least one of at least three pockets.

10. A hammer wrench for applying torque to a union used to join pipes, the hammer wrench comprising:
a c-shaped body having at least two pockets along an inner face that each permit a wing of the union, wherein each of the at least two pockets admits a wing from a direction axial to the c-shaped body, and each of the at least two pockets presents a stop to capture a respective wing thereby preventing further axial travel of the c-shaped body relative to the union, wherein each of the at least two pockets is disposed at up to a 120° angle to a second one of the at least two pockets;
a radially disposed hammer post extending outwards from an outer face of the c-shaped body, wherein the hammer post provides two faces surfaces, a first face of the two faces has a surface normal that opposes the surface normal of a second face of the two faces such that each surface normal is approximately tangential to an arc centered on an axis to the c-shaped body.

11. The hammer wrench of claim 10, wherein the at least two pockets are five pockets.

12. The hammer wrench of claim 10, wherein the c-shaped body has first a through-hole, parallel to the axis, near a first distal end of the c-shaped body and the c-shaped body has a second through-hole at a second distal end of the c-shaped body.

13. The hammer wrench of claim 14, wherein a coordinating capture element attaches to the hammer wrench at least at a first through-hole and a second through-hole.
